(19) United States
(12) Patent Application Publication
(10) Pub. No.: US 2009/0142654 A1
(43) Pub. Date: Jun. 4, 2009

(54) COMPACT POWER SUPPLY DEVICE FOR A MOTOR VEHICLE COMPRISING REGULATED COOLING MEANS

(76) Inventors: Michel Fakers, Seclin (FR); Richard Tellier, Paris (FR); Claudiu Vasilescu, Paris (FR); Fabien Guerin, Chatillon (FR); Julien Masfaraud, Paris (FR); Roger Abadia, Neuilly-Plaisance (FR)

Correspondence Address: BERENATO, WHITE & STAVISH, LLC, 6550 ROCK SPRING DRIVE, SUITE 240, BETHESDA, MD, 20817, US

(21) Appl. No.: 12/303,336

(22) PCT Filed: Jun. 28, 2007
(86) PCT No.: PCT/FR2007/051556

§ 371 Date: Dec. 3, 2008

(30) Foreign Application Priority Data
Jun. 30, 2006 (FR) 0652741

(51) Int. Cl. H01M 10/50; F28F 13/00

(52) U.S. Cl. 429/120; 165/185

(57) ABSTRACT

A power supply device for a motor vehicle, comprising a housing containing at least one unit for storing electrical energy and cooling means of the unit consisting of at least two cooling devices which can be selectively controlled by control means for regulating the quantity of heat to be dissipated by the cooling means.

### TECHNICAL DOMAIN OF THE INVENTION

The invention proposes an electrical power supply device for a motor vehicle, which is intended to connect at least one electrical machine to a battery of the vehicle, and which includes a housing in which at least one unit for storing electrical energy is arranged, and including cooling means for said at least one storage unit, said housing including a container for at least one electrical energy storage unit.

### STATE OF THE ART

Many examples of devices of this type are known in the art.

Such electric power supply devices are used, for example, to power electric machines in motor vehicles of the electric and/or hybrid type, i.e. combining an electric machine and a conventional thermal engine, for which it is important to be able to recuperate kinetic energy in order to recharge the vehicle's battery and to supply the on-board systems with electric power. This function is currently referred to as recuperative braking. For example, a metal hydride type battery can be used.

However, these electric power supply devices pose a number of problems.

In fact, the energy storage units undergo many charge and discharge cycles. For example, when the motor vehicle starts, a very intense discharge of electricity is produced. Another example is that the storage units are charged with a high-intensity electric current during periods of recuperative braking.

When electric current is released, during the discharge operations, or stored, during the charging operations, the storage units give off heat. The quantity of heat given off is proportional to the intensity of the electric current circulating in charge or in discharge mode.

Moreover, these charge and discharge cycles are likely to follow each other in very rapid succession, especially when the vehicle is being driven in town and the driver has to stop and start the vehicle frequently.

And yet, for the storage units to be able to store electric current effectively, they must be maintained within a range of operating temperatures bounded by a maximum operating temperature and a minimum operating temperature.

When charge and discharge cycles follow each other in rapid succession, the temperature of the storage units tends to rise very rapidly beyond the maximum operating temperature. The rise in temperature of the storage units is all the more rapid if the storage units are housed in a closed container.

### SUMMARY OF THE INVENTION

In that case, it is desirable to use cooling means to dissipate or to evacuate the heat given off by these storage units.

The object of the invention is to propose effective means of cooling the electric power supply device, in order to improve the quantity of heat evacuated by the cooling means.

With this aim, the invention proposes a power supply device of the type already described, characterised in that the cooling means include at least two cooling devices which can be controlled selectively by control means in order to regulate the quantity of heat which the cooling means are intended to dissipate.

With the aid of the invention, the quantity of heat to be dissipated is effectively regulated, thus obtaining better cooling of the energy storage unit or units.

According to other non-limitative characteristics of the invention, taken separately or in combination:
the cooling devices are independent of each other;
the quantity of heat intended to be dissipated by one of the cooling devices is different from the quantity of heat intended to be dissipated by another of the cooling devices;
the control means are capable of regulating the quantity of heat which can be dissipated by each cooling device;
the cooling means include a cooling device equipped with a cold section of a cooling circuit of the vehicle;
the cooling means include at least one fin heat sink;
the cooling means include means of generating a flow of air directed towards said at least one fin heat sink and controlled by the control means;
the cooling means include several fin heat sinks and means of producing a flow of air which is associated with each fin heat sink;
the cooling means include at least one fin heat sink which is in direct contact with said at least one storage unit;
the power supply device includes means of thermal insulation of said storage unit.

### BRIEF DESCRIPTION OF THE FIGURES

Other characteristics and advantages of the invention will become apparent on reading the detailed description which follows, which will be better understood by making reference to the appended figures, in which:

FIG. 1 is a skeleton diagram of an electric power supply device according to the invention,

FIG. 2 is an exploded perspectival view of a first embodiment of an electric power supply device,

FIG. 3 is a diagrammatic perspectival representation of an exploded image of the container of the power supply device shown in FIG. 2, including two fin heat sinks fitted on the container,

FIG. 4 is a view similar to that in FIG. 3, in which the container bears a single fin heat sink, and

FIG. 5 is a detailed view of the storage units illustrated in FIG. 4, representing a variant embodiment of the invention, according to which each of the storage units bears one fin heat sink.

### DETAILED DESCRIPTION OF THE FIGURES

In the following description, identical reference numbers refer to identical parts, or those which have similar functions.

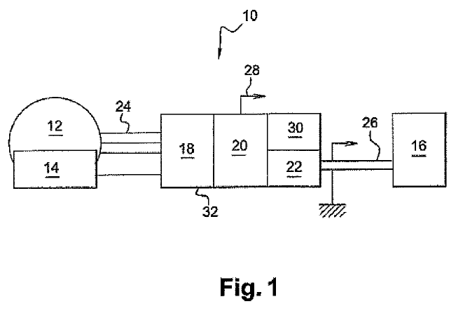

FIG. 1 represents the whole electric power supply device 10 for a motor vehicle realised according to the invention.

The device 10 is intended to connect at least one electric machine 12 to a battery of the motor vehicle with a thermal engine. This machine 12 is rotary, and is equipped with sensors 14 to detect the position of its rotor. It is capable of functioning as an electric motor, for example in order to start the thermal engine of the vehicle, or even to drive at least one wheel of the vehicle and/or as an electrical generator, for example to recuperate the vehicle's kinetic energy during braking, and store it in a battery 16 of the vehicle. This machine, such as an alternator-starter, is referred to as reversible. This machine is taken as a non-limitative example for the rest of the description.

As a reminder, it will be recalled that an alternator-starter is a reversible alternator enabling, firstly, mechanical energy to be transformed into electric energy when it operates in electric generator mode, in particular to recharge a battery and/or to power the consumers of at least one on-board system of the motor vehicle and secondly, to transform electric energy into mechanical energy when it operates in electric motor mode, known as starter mode, in particular to start the internal combustion engine or thermal engine of the motor vehicle and, in one embodiment, to prevent the thermal engine from stalling.

This alternator-starter includes means of rectifying current, known as a current inverter, including for example transistors of the MOSFET type, which are governed by an electronic command and control unit as described for example in the documents FR A 2 745 444 and FR A 2 745 445.

This electronic command and control unit receives the signals from sensors detecting the angular position of the rotor of the machine and also include pilots, known as drivers, which are the power modules which control the MOSFET-type transistors. These drivers, in one embodiment, belong to a power stage which also includes the MOSFET-type transistors of the inverter constituting a reversible AC-DC current converter in electric generator mode. In electric motor mode, the MOSFET transistors of the inverter are controlled in all-or-nothing mode for full wave control of the stator windings of the machine or, as a variant, by means of variable pulse width control, i.e. a switching technology known in French as MLI (modulation par largeur d'impulsion) and in English as PWM (pulse width modulation).

The control elements form part of a lower-power control stage.

In one embodiment, the power stage includes an electronic power card bearing the power elements, such as the MOSFET-type transistors and the drivers, and the control stage includes an electronic control card bearing the control elements.

In these aforementioned documents, the alternator-starter is polyphased.

In an embodiment described in the documents WO 02/080334 and WO 03/088471, the alternator-starter forms part of an arrangement for a motor vehicle including at least two electrical energy storage units One of these storage units is a battery and the other a super capacitor, i.e. a high-value capacitor referred to as an ultra-capacitor. It will be noted that in starter mode (operation in electric motor mode), this arrangement allows the alternator-starter to be supplied at a voltage greater than that in generator mode.

This type of arrangement allows energy to be recuperated during braking and includes two electric distribution networks, at least one change-over switch or a circuit with two switches and a DC-DC converter, enabling voltages to be converted and able to operate at two different voltages.

For further details, reference should be made to said documents, bearing in mind that the inverter is an electronic current converter.

Obviously, this arrangement makes use of a rotating electric machine, such as a simple alternator connected electrically to a battery.

In one embodiment, this alternator is associated with a starter mounted in parallel with the alternator between a first terminal connected to earth and a second terminal connected to a circuit allowing, in one embodiment, two batteries, for example 12V, to be arranged in series to power the starter at 24V when starting and to place these two batteries in parallel after the motor vehicle has started.

The device 10 thus includes at least one electronic converter 18, 22 and one electrical energy storage unit 20. This device includes two electrical networks, one dedicated to power (the storage units 20 being in series) and suitable for the recuperation of energy, the other dedicated to energy, specifically for recharging the battery 16 connected to the on-board system of the vehicle and/or to power this on-board system.

In a first non-limitative embodiment, the device 10 includes a DC-DC converter 22.

In a second non-limitative embodiment, the device 10 includes an inverter 18. The inverter is a reversible DC-AC converter. It operates as an AC-DC converter when the machine is in electric generator mode (it is often referred to as a bridge rectifier), and as a DC-AC converter when the machine is in electric motor mode.

In a third, non-limitative, embodiment, the device 10 includes an inverter 18 and a DC-DC converter 22.

In a fourth embodiment, in the non-limitative sample embodiment as shown in FIG. 1, the device 10 includes three electronic converters, i.e. an inverter 18, a DC-DC converter 22, and also a two-position switch 30 or two switches 30 which are interconnected by power connections such as bus bars (not shown).

The inverter 18, in the aforementioned manner, is a reversible AC-DC current converter in electric generator mode or AC-DC in electric motor mode.

The DC-DC converter 22 makes it possible, in particular, to convert a voltage from the energy storage unit 20, said voltage falling within a range of values, in this instance, non-limitatively between 6V and 35V, into a voltage compatible with that of the battery 16, the battery powering an on-board system, for example in the order of 12 volts.

The two-position switch 30 (or switches 30) in turn allows the mode of operation of the electric machine 12 to be determined.

In the example taken, the generator mode consists of two phases: one referred to as the alternator phase, and one referred to as the energy recuperation phase, and the motor mode consists of a phase of starting and dynamic assistance.

The mode of operation of the machine with a two-position switch is as follows:
the switch connects the inverter 18 and the storage unit 20 in motor mode, and in the energy recuperation phase,
the switch connects the inverter 18 and the battery 16 in the alternator phase.

It will be noted that in another embodiment, there is no switch.

For this purpose, the device 10 is connected via cables 24 to the electric machine, via cables 26 to the battery, and via cables 28 to an electric power supply system of the vehicle.

As the device 10 enables the kinetic energy of the vehicle to be recuperated with the aid of the electric machine, this architecture is more specifically known under the name of “14+X” architecture.

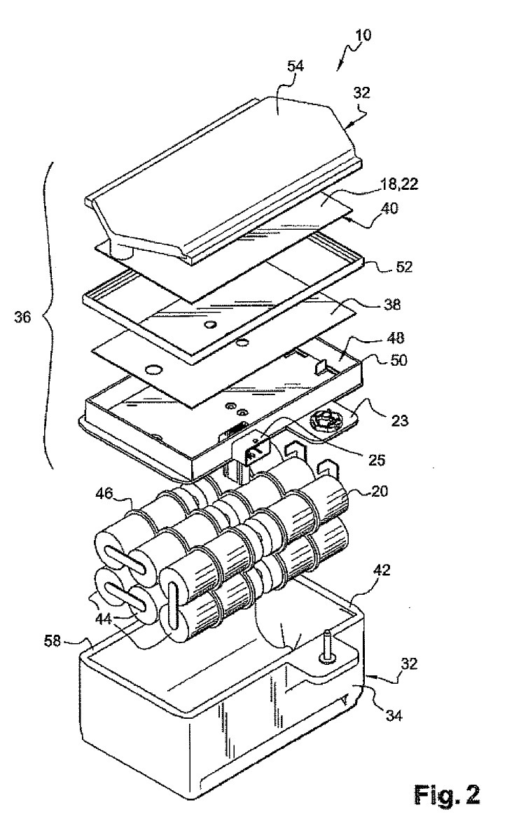

As illustrated by FIGS. 1 and 2, the device 10 includes a single housing 32 in which are arranged the electronic converter(s) 18, 22 and the electrical energy storage unit(s) 20, in particular to reduce the lengths of the connections between these elements, so as to limit the effects of the connection inductances.

In general, the housing 32 consists of a lower part 34, forming a container 34 to receive at least one electrical energy storage unit 20.

This lower part 34 is supplemented by at least one upper part 36, covering the lower part 34, and holding at least one electronic control card 38 and at least one electronic power card 40 which contains the electronic converter(s) 18, 22, 30, i.e. the inverter 18, the DC-DC converter 22, and the two-position switch 30.

More specifically, the lower part 34 exhibits the shape of a first container which is more or less parallelepiped, open at its upper end 42, which holds at least two electrical energy storage unit 20 known as “super capacitors” or ultra-capacitors, mounted in series.

In a first, non-limitative, sample embodiment, the storage units 20 are arranged lengthwise.

In a second, non-limitative, embodiment, the storage units 20 are arranged widthwise.

In a third, non-limitative, embodiment, the storage units 20 are arranged heightwise.

According to one variant embodiment, the storage units 20 are arranged partly lengthwise and partly widthwise or heightwise.

Depending on the dimensions of the storage units 20, the best arrangement can be selected for the three modes so as to optimise the space necessary for the electronic components integrated in the housing 32, in this particular example heightwise.

In a first variant applicable to all three modes, the energy storage units 20 are arranged in stages, the units 20 of a first stage being offset in relation to the second stage such that two units 20 of the second stage are in tangential contact with a same unit 20 from the first stage. The contact may be direct or indirect.

In a second variant applicable to all three modes, as shown in FIG. 2, the lower part holds axial rows 44 of electrical energy storage units 20 which are arranged lengthwise, but this arrangement does not limit the invention. The rows 44 of the electrical energy storage units 20 could in fact be arranged widthwise. The energy storage units of two adjacent rows are held in place by retention means 46. Any embodiment of these retention means may be suitable for the correct implementation of the invention. In the figures, the retention means are composed of elastic collars 46, but they could be formed integrally to the lower part 34, or else to the electrical energy storage units 20 themselves, each of which will then include fitting means intended to co-operate with the adjacent unit 20.

The units 20 in the embodiment shown in FIG. 2 have a globally cylindrical shape with a circular section.

Obviously, as a variant these units 20 of elongated form could have a different section, for example a polygonal shape, such as a hexagonal section. As a variant, the section is oval.

The upper part 36, in turn, includes a second container 48 which covers the upper end 42 of the first container 34.

This second container may, in particular, carry external connectors, for example a connector 23 intended to receive control signals and a connector 25 intended to receive electric power.

The second container 48 is open at its upper end 50, and it is intended to hold successively, preferably from bottom to top of the container 48, the electronic control card 38, an insulation seal 52, and the electronic power card 40 containing the inverter 18 and the DC-DC converter 22, and a cover 54 covering the upper end 50 of the second container 48. Said cover 54 contains the upper cooling means. Preferably, the power card 40 is positioned as close as possible to the upper cooling means. This arrangement will thus prevent the storage units 20 from being heated by the heat given off by the power card. The base of the second container 48 is advantageously made of electrically-insulating material in order to prevent any heating of the storage units.

The energy storage units 20 undergo many charge and discharge cycles. For example, when the motor vehicle starts, a very intense discharge of electricity is produced. Another example is that the storage units 20 are charged with a high-intensity electric current during periods of recuperative braking.

When electric current is released, during the discharge operations, or stored, during the charging operations, the storage units 20 give off heat. The quantity of heat given off is proportional to the intensity of the electric current circulating in charge or in discharge mode.

Moreover, these charge and discharge cycles are likely to follow each other in very rapid succession, especially when the vehicle is being driven in town and the driver has to stop and start the vehicle frequently.

And yet, for the storage units 20 to be able to store electric current effectively, they must be maintained within a range of operating temperatures bounded by a maximum operating temperature and a minimum operating temperature.

According to one characteristic, to maintain the temperature of the storage units below a maximum operating temperature, the first container 34 includes cooling means enabling some of the heat generated by the storage units 20 to be dissipated.

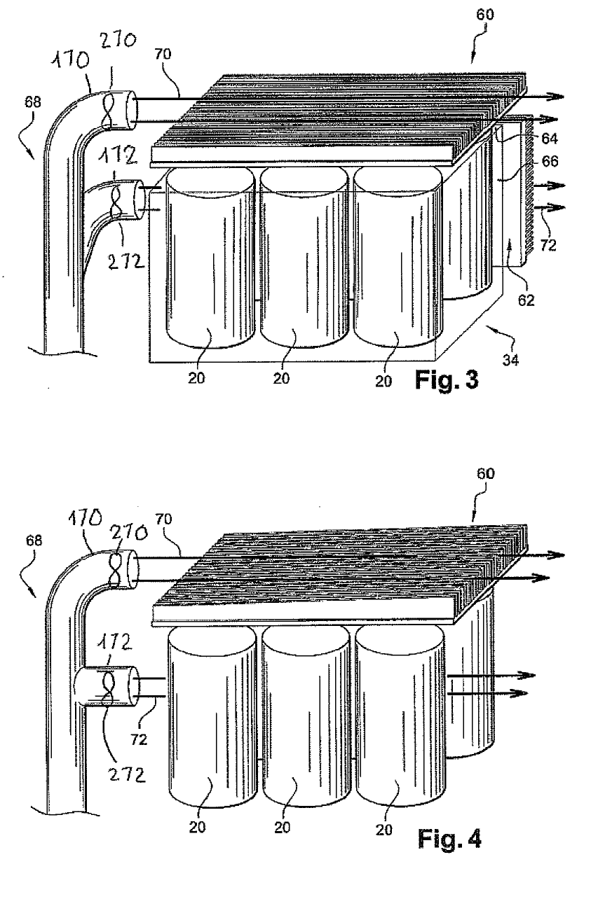

In the embodiments in FIGS. 3 to 5, the cooling means include a first cooling device 60 and a second cooling device 62, each of which consists, in this case, of a fin heat sink.

As can be seen in FIG. 3, here the first cooling device 60 is arranged in the region of a first side 64 of the first container 34 and the second cooling device 62 is arranged in the region of a second face 66 of the container 34.

The cooling means contain a system 68 for generating a flow of air directed towards each of the two cooling devices 60, 62 in order to promote the dissipation of heat by the cooling devices by means of convection.

The system 68 constitutes one embodiment of means of generating a flow of air.

Thus, a first flow of air 70 is directed towards the first cooling device 60 and a second flow of air 72 is directed towards the second cooling device 62.

According to one characteristic, the cooling means include means of controlling the cooling devices to vary the quantity of heat which the cooling devices 60, 62 are intended to dissipate.

According to one characteristic, the two cooling devices 60, 62 can be controlled selectively for better regulation of the heat which the cooling means are intended to dissipate.

According to a first embodiment, the control means are executed in such a way as to vary the rate of the two flows of air 70, 72 directed towards each of the cooling devices 60, 62.

According to a first embodiment, the control means are realised in such a way that when the quantity of heat to be dissipated by the cooling means is relatively low, the rate of the flows of air 70, 72 is zero, and when the quantity of heat to be dissipated increases, when the storage units 20 give off heat during discharge operations, or during charging operations, the rate of the flows of air 70, 72 increases.

According to another embodiment, the control means are realised in such a way that one or other of the two flows of air 70, 72 is produced.

In this case, the first cooling device 60 is larger and is capable of dissipating a greater quantity of heat than the second cooling device 62.

Thus, for example, when the quantity of heat to be dissipated is small, only the second flow of air 72 associated with the second cooling device 62 is produced, and when the quantity of heat to be dissipated becomes greater, it is the first flow of air 70 alone which is produced, and when the cooling means have to dissipate a maximum quantity of heat, the two flows of air 70, 72 are produced simultaneously.

FIG. 4 represents one variant embodiment according to which the cooling means consist of a single cooling device 60, which here too consists of a fin heat sink.

The cooling means, on the other hand, include means of producing two different flows of air 70, 72. The first flow of air 70 is associated with the cooling device 60, to increase its capacity to dissipate heat by forced convection. The second flow of air 72 circulates within the first container 34, in such a way as to cool the storage units 20 directly by convection.

In a way similar to the embodiment previously described in reference to FIG. 3, the means 68 of production of the flows of air are controlled using the control means, in order to vary the rate of each of the flows of air 70, 72 depending on the heat given off by the storage units 20.

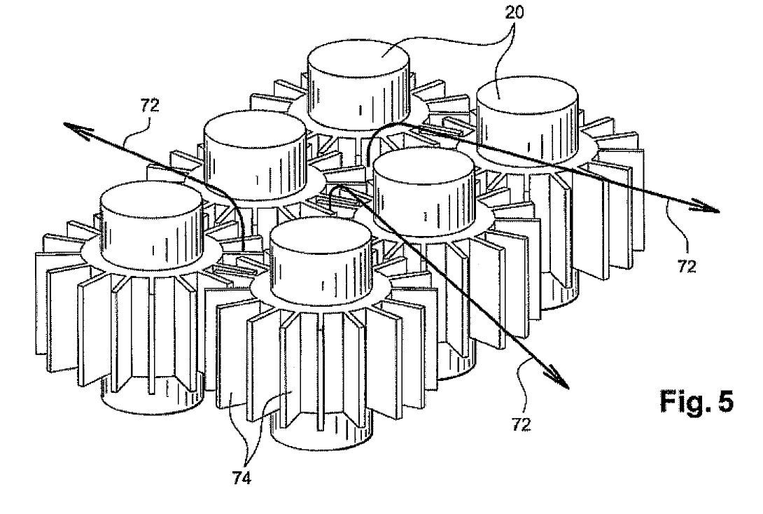

To improve the direct cooling of the storage units 20, and as can be seen from the variant shown in FIG. 5, a cooling fin heat sink 74 is mounted on each storage unit 20 in order to promote heat exchange by convection with the second flow of air 72.

According to one variant, the means of producing the flows of air 68 are able to circulate a single flow of air 70 or 72 towards just one of the two heat sinks 60 or 62, and the control means are able to vary the rate of this flow of air 70 or 72 depending on the quantity of heat to be dissipated.

According to one variant embodiment, not shown, the cooling means contain a cold section of a cooling circuit of the vehicle, which is able to absorb a certain quantity of the heat produced by the storage units, and the control means are able to control the circulation of cooling liquid in this cold section, depending on the quantity of heat to be dissipated.

According to yet another variant embodiment, not shown, the cooling means include a Peltier effect cell.

According to the known principle of the Peltier effect, when the cell is powered by electric current, one of its faces becomes cold, i.e. it absorbs heat, while the other face becomes hot, i.e. it gives off heat. In other words, the Peltier effect cell acts as a heat pump, which absorbs heat by one face to re-emit it by the other face.

Thus, by modifying the intensity of the electric current powering the Peltier effect cell, via the control means, it is possible to vary the quantity of heat absorbed by the face referred to as “cold”.

Thus, by using the control means of the cooling devices according to the invention, adjusting the quantity of heat which the cooling means are able to dissipate, it is possible to limit the energy consumed by the cooling means to dissipate the heat.

What is more, according to another aspect of the invention, in order to limit the heating of the storage units 20, the container 34 also includes means for thermally insulating the storage units 20 to prevent part of the heat produced by elements external to the power supply device 10, for example the motor of the vehicle or again, the radiator of the cooling system of the motor, being transmitted to the storage units 20.

It will be understood that the invention is not limited solely to the cooling devices of the storage units which have just been described, and that the container may contain other cooling devices which can be controlled or driven by the control means according to the invention.

It will also be understood that in addition to the driven cooling devices as previously described, the power supply device 10 may also contain cooling means which operate constantly or continuously, for example means to link the storage units thermally to a cold source of the vehicle.

Thus, for example, the power supply device 10 contains a heat pipe thermally connecting the storage units to a cold part of the body of the vehicle.

Obviously, according to a further variant, the power supply device 10 may contain only one storage unit 20.

As is apparent from the description and the drawings, the two flows of air 70, 72 are directed in the same direction. The means of production of the flows of air 68 include a conduit 170, 172 respectively for each of the flows of air 70, 72.

The two cooling devices are independent of each other.

The fin heat sink 60 in FIGS. 3 and 4 covers the container 34 and replaces the upper part 36 so that the electronic module in FIG. 2 is offset. As a variant, the heat sink 60 is mounted on the other longitudinal edge of the container 34, i.e. parallel to the other fin heat sink 62 mounted on the other edge In this case, the upper part of FIG. 2 can be conserved. As a variant, the heat sink 60 is mounted on the lower face of the container 34.

As a variant, at least three faces of the container are covered by a fin heat sink, each heat sink being swept by a flow of air, the flows of air being independent of each other.

As a variant, the three faces of the container are covered, for example, by two fin beat sinks and one Peltier effect cell with a variable quantity of absorbed heat.

It is possible to combine a fin heat sink device swept by a flow of air with an independent Peltier effect cell and/or an independent cold section of a cooling circuit of the vehicle.

Any number of combinations is possible, depending on the applications; the two cooling devices being controlled selectively, for example at different times, by the control means in order to dissipate the heat better.

A fan, 270, 272 respectively may be mounted in each conduit 170, 172.

Each fan 270, 272 is in a drivable embodiment, for example depending on the temperature of the energy storage unit(s) 20. To this end, it is possible to provide a temperature sensor inside the container 34.

This sensor then commands the starting of the fans, for example in selective fashion. The fans may operate subject to a delay.

As described above by way of example, when there is little heat to be dissipated, only the second flow of air 72 associated with the second cooling device 62 is produced; the fan 272 is then operative and the fan 170 inoperative. When the amount of heat to be dissipated increases, then it is the first flow of air 70 alone which is produced; the fan 270 then being operative and the fan 272 inoperative.

When the cooling means have to dissipate a maximum amount of heat, both flows of air 70, 72 are produced simultaneously and both fans 270, 272 are operative.

The rates of the air flows 70, 72 can be increased selectively by increasing the speed of the fan concerned. A speed regulator may thus be associated with each fan. This regulator receives information about the quantity of heat to be dissipated and in particular about the temperature of the units 10.

For example, as explained above, the rate of the air flows 70, 72 may be zero at the start and then increase, and this can be done selectively, the rate of flow 70 increasing selectively, for example, more than the rate of flow 72.

The size of the conduit 170 is, in one embodiment, different from that of the conduit 172.

The conduits 170, 172 can be independent of each other, or as a variant, as can be seen in FIG. 4, include a common part.

The fin heat sinks and the flows of air are, nevertheless, independent of each other.

As described in the document WO 02/080334, the device 10 may be intended to connect a rotating electric machine to two on-board systems and to two batteries with different voltages.

The container may simultaneously contain “super capacitors” and a battery.

1. Electric power supply device (10) for a motor vehicle, which is intended to connect at least one electric machine (12) to a battery (16) of the vehicle, and which consists of a housing (32) in which is arranged at least one electrical energy storage unit (20), and including cooling means (60, 62, 70, 72) for said at least one storage unit (20), said housing including a container to hold at least one electric energy storage unit,
wherein the cooling means include at least two cooling devices (60, 62) which can be selectively controlled by control means to regulate the quantity of heat which the cooling means (60, 62) are intended to dissipate.

2. Power supply device (10) according to claim 1, wherein the quantity of heat intended to be dissipated by a first cooling device (60) is different from the quantity of heat intended to be dissipated by a second cooling device (62).

3. Power supply device (10) according to claim 1, wherein the control means are able to regulate the quantity of heat which can be dissipated by each cooling device (60, 62).

4. Power supply device (10) according to claim 1, wherein the cooling means include a cooling device equipped with a cold section of a cooling circuit of the vehicle.

5. Power supply device (10) according to claim 1, wherein the cooling means include at least one fin heat sink (60, 62, 74).

6. Power supply device (10) according to claim 5, wherein the cooling means include means (68) of producing a flow of air (70, 72) directed towards said at least one fin heat sink (60, 62, 74) and controlled by the control means.

7. Power supply device (10) according to claim 5, wherein the cooling means include several fin heat sinks (60, 62, 74), and wherein the cooling means include means (68) of producing a flow of air (70, 72) which is associated with each fin heat sink (60, 62, 74).

8. Power supply device (10) according to claim 7, wherein the cooling means include at least one fin heat sink (74) which is in direct contact with said at least one storage unit (20).

9. Power supply device (10) according to claim 1, further including means of thermal insulation of said storage unit (20).

10. Device according to claim 1, wherein the two cooling devices are independent of each other.
